(19) United States
(12) Patent Application Publication
(10) Pub. No.: US 2025/0390878 A1
(43) Pub. Date: Dec. 25, 2025

(54) ARTIFICIAL INTELLIGENCE BASED SYSTEMS AND METHODS FOR EARLY DETECTION OF ANOMALOUS BEHAVIOR AT OFF-NETWORK ACCOUNTS

(71) Applicant: MASTERCARD INTERNATIONAL INCORPORATED, Purchase, NY (US)

(72) Inventor: Deepak Bhatt, O'Fallon, MO (US)

(21) Appl. No.: 18/750,787

(22) Filed: Jun. 21, 2024

(51) Int. Cl. G06Q 20/40; G06Q 20/38

(52) U.S. Cl. CPC G06Q 20/4016; G06Q 20/389

(57) ABSTRACT

A graphical modeling computer system is configured to: (i) receive transaction data for a plurality of transactions including declined transactions and approved transactions; (ii) parse the transaction data to identify each pair of a respective payment node and a respective funding node associated with each transaction of the plurality of transactions; (iii) build a graphical model showing all transactions of the plurality of transactions initiated from each funding node to a corresponding payment node; (iv) train the graphical model by labeling each transaction as either a completed transaction or a declined transaction; (v) train the graphical model by applying fraud labels to each transaction, by mapping aggregated parameters to each payment node, and by associating transaction features to each incoming or outgoing transaction for the payment nodes; and (vi) output from the trained graphical model an indication of the payment nodes associated with suspicious activity.

### BACKGROUND

The field of the disclosure relates generally to systems and methods for using artificial intelligence to detect early-stage anomalous behavior at an off-network account level, and, more particularly, to network-based systems and methods that use artificial intelligence modeling and graph analytics to detect at an early-stage fraudulent transactions at an off-network account level that are performed over a payment network.

In today's world, most payment transactions are performed between a merchant and an accountholder or a cardholder using a payment card or payment account such as a credit card or a debit card. The credit card or debit card may be used at a point-of-sale (POS) device of a merchant (sometimes referred to as a card present or CP transaction), or in an online transaction through e-commerce (sometimes referred to as a card-not-present or CNP transaction), or at an automatic teller machine (ATM) to make payment for a purchase of goods/services, transfer of money, and/or for cash withdrawal. The particular POS, computing device, or ATM where the credit card or debit card is used is generally referred as a payment node. From the payment node, an electronic request message is then sent to an acquirer bank. The acquirer may be the merchant or the bank of the merchant, and may be the owner of the POS or the ATM. After receiving the transaction request message through the network, the acquirer bank may then generate and send an electronic authorization request message to an associated payment network system for processing the payment transaction. The card network's payment network system may then communicate with the issuer bank (the bank issuing the card or account) and may receive a response from the issuer bank which may indicate whether the transaction is approved or declined. The issuer bank is generally referred to as a funding node.

In other cases, payment requests or money transfer requests may occur between two individuals. These payment requests may occur as a push payment or as a pull payment. The push payment is where the funding node or the bank account of the payor pushes the money or funds out to the payee or the payment node. This may occur when a payor transfers money to a payee. In the case of the pull payment, the payee or the payment node may send a payment request to the payor or funding node, and request that the funds be transferred.

During a given day, between a payment node and a funding node, multiple transactions may be executed using multiple different credit cards or debit cards. Generally, most of the credit card and debit card transactions are legitimately performed by the legitimate owners of the credit cards or debit cards where payment is made to a legitimate payment node. However, sometimes these transactions are performed by fraudsters. In other words, fraudulent payees may attempt to access funds associated with legitimate credit cards or debit cards and attempt to transfer funds to a fraudulent payment node; or a fraudster may try to use a stolen credit card or debit card to purchase goods. In either case, fraud is being committed. In many cases, fraudsters may randomly try various credit card and/or debit card account numbers in an attempt to send and/or receive money which may not have been known to the actual owners of the credit cards or debit cards or may not have been approved by the actual owners of the credit cards or debit cards.

Oftentimes, the fraudsters may use cards that are of a particular network brand or may be associated with a particular issuing bank (the fraudsters may use the Bank Identification Number (BIN) for a particular issuing bank) in order to initiate their fraudulent payment attempts. While the frauds may be either a push payment fraud or a pull payment fraud depending on the particular way in which the fraud payment is received, oftentimes the fraud may be reported by the owner of the credit card or debit card. However, the owner of the credit card or the debit card will typically identify the fraud with respect to a particular transaction and typically after the fraud is committed. Identification of a fraud at the transaction level is generally not enough to identify bad actors or fraudsters for various reasons including, but not limited to, incomplete information available for the alleged fraudulent transaction, incomplete or incorrect amount of fraud corresponding to the fraudulent transaction, fraud identified only for a particular account which can easily be changed by the fraudster, and so on. Most known fraud detection systems are also designed to evaluate for fraud at the transaction level and not at an account level. In other words, these known fraud detection systems will look at a particular transaction and decide if it is more likely fraud or not. These known systems are unable to evaluate for fraud at an account level—where the fraudster is identified and not just a particular transaction. So, these known systems are unable to detect bad actors that may repeatedly try to scam the system and commit fraud.

Accordingly, there is a need for a system and method that is configured to evaluate all aspects of an account-to-account (A2A) ecosystem and to identify fraudulent transactions at the account level, even when the account is an off-network account (e.g., an account associated with a second payment network used to receive money processed by a first network). Such a system would be able to detect bad actors within the system and prevent them from committing repeated fraud within the system and prevent widespread fraud attacks.

### BRIEF DESCRIPTION

In one aspect, a graphical computer system including at least one memory, and at least one processor in communication with the at least one memory is disclosed. The at least one processor is configured to: (i) receive transaction data for a plurality of transactions processed over a payment network, the plurality of transactions including a first set of declined transactions and a second set of approved transactions; (ii) parse the transaction data to identify each pair of a respective payment node and a respective funding node associated with each transaction of the plurality of transactions; (iii) build a graphical model showing all transactions of the plurality of transactions initiated from each funding node to a corresponding payment node over a period of time; (iv) train the graphical model by labeling each transaction as either a completed transaction or a declined transaction; (v) train the graphical model by applying fraud labels to each transaction; (vi) train the graphical model by mapping aggregated parameters to each payment node; (vii) train the graphical model by associating transaction features to each incoming or outgoing transaction for the payment nodes; and (viii) output from the trained graphical model an indication of the payment nodes that are determined to be associated with suspicious activity based upon the aggregated parameters, the fraud labels, and the associated features assigned to each payment node.

In another aspect, a computer-implemented method performed using a graphical modeling computer system is disclosed. The graphical modeling computer system includes a memory and at least one processor in communication with the memory. The computer-implemented method includes: (i) receiving transaction data for a plurality of transactions processed over a payment network, the plurality of transactions including a first set of declined transactions and a second set of approved transactions; (ii) parsing the transaction data to identify each pair of a respective payment node and a respective funding node associated with each transaction of the plurality of transactions; (iii) building a graphical model showing all transactions of the plurality of transactions initiated from each funding node to a corresponding payment node over a period of time; (iv) training the graphical model by labeling each transaction as either a completed transaction or a declined transaction; (v) training the graphical model by applying fraud labels to each transaction; (vi) training the graphical model by mapping aggregated parameters to each payment node; (vii) training the graphical model by associating transaction features to each incoming or outgoing transaction for the payment nodes; and (viii) outputting from the trained graphical model an indication of the payment nodes that are determined to be associated with suspicious activity based on the aggregated parameters, the fraud labels, and the associated features assigned to each payment node.

In yet another aspect, at least one non-transitory computer-readable storage medium including computer-executable instructions embodied thereon is disclosed. The computer-executable instructions are executed by at least one processor of an interchange network computer to: (i) receive transaction data for a plurality of transactions processed over a payment network, the plurality of transactions including a first set of declined transactions and a second set of approved transactions; (ii) parse the transaction data to identify each pair of a respective payment node and a respective funding node associated with each transaction of the plurality of transactions; (iii) build a graphical model showing all transactions of the plurality of transactions initiated from each funding node to a corresponding payment node over a period of time; (iv) train the graphical model by labeling each transaction as either a completed transaction or a declined transaction; (v) train the graphical model by applying fraud labels to each transaction; (vi) train the graphical model by mapping aggregated parameters to each payment node; (vii) train the graphical model by associating transaction features to each incoming or outgoing transaction for the payment nodes; and (viii) output from the trained graphical model an indication of the payment nodes that are determined to be associated with suspicious activity based on the aggregated parameters, the fraud labels, and the associated features assigned to each payment node.

### BRIEF DESCRIPTION OF THE DRAWINGS

FIG. 1 is a schematic diagram illustrating an example multi-party payment card industry system for enabling payment transactions between cardholders, merchants and card issuers in accordance with the present disclosure.

FIG. 2 illustrates an example relationship diagram between a payment node and a funding node in accordance with the present disclosure.

FIG. 3A is an illustration of an example embodiment of mapping transactions into an account to account (A2A) graph model in accordance with the present disclosure.

FIG. 3B is an illustration of an example graphical multi-layer model based on the A2A graph model shown in FIG. 3A.

FIG. 3C is a graphical illustration of an example life cycle of a payment node and transactions performed by the payment node in accordance with the present disclosure.

FIG. 4 is a simplified block diagram of an example computer system representative of a fraudulent transaction identification service computer system in the payment processing environment as shown in FIG. 1.

FIG. 5 illustrates an example configuration of a cardholder computer system operated by a cardholder as shown in FIG. 1.

FIG. 6 illustrates an example configuration of the server computer system as shown in FIGS. 1 and 4.

FIG. 7 is a flow diagram of an example method of identifying fraudulent transactions which may be implemented by the computer system shown in FIG. 4.

FIG. 8 is a flow diagram of another example method of identifying payment nodes associated with suspicious activity, which may be implemented by the computer system shown in FIG. 4.

### DETAILED DESCRIPTION OF THE DISCLOSURE

The following detailed description illustrates embodiments of the disclosure by way of example and not by way of limitation. It is contemplated that the systems and processes described herein have general application to the aspect of processing payment card transactions. More specifically, the embodiments of the systems and methods described herein relate generally to identifying all aspects of an account-to-account (A2A) ecosystem, frauds and their scope at the account level, and bad actors (or fraudsters) committing frauds at the account level. Additionally, various embodiments describe techniques to identify such accounts operated by bad actors earlier to reduce the scope of frauds committed by the bad actors and in those cases where the transaction involves an off-network account. Accordingly, the systems and methods described herein are configured to detect payment accounts that are involved in fraudulent or suspicious activities at an early-stage, and deploy mitigation resources (e.g., computation resources to help mitigate the fraud) to address and/or prevent the fraud. The system and method described herein are able to capture a full view of the suspicious account activities, and are able to differentiate legitimate transaction activities from the fraudulent activities. As compared to currently known systems that merely focus on each individual transaction, the system described herein focuses on transactions at an account level and determines who the bad actors are at the account level.

Described in detail herein are example embodiments of systems and methods for (i) identifying all transactions initiated within an account-to-account (A2A) ecosystem including features associated with each transaction, wherein the features associated with each transaction are stored in memory and include data elements associated with or relating to the transaction; (ii) build a transaction graphical model showing all transactions initiated from a funding source (a payor) to a payment receiving source (payee) over a period of time, wherein the payment receiving source may be part of the payment network or may be outside of the payment network (e.g., off-network); (iii) train and build a graphical node and edge model that shows all completed (existent) transactions (e.g., legitimate and fraudulent) between the funding sources (or the funding nodes) and the payment sources (or the payment nodes), and that shows all declined (non-existent) transactions between the funding nodes and the payment nodes; (iv) further train the graphical node and edge model by applying fraud labels to each transaction that has been labeled a fraudulent transaction such that each payment node indicates one or more incoming transactions (edges) with each incoming transaction being labeled as either approved, declined, or confirmed fraudulent, and doing the same for each outgoing transaction from the funding nodes; (v) further train the graphical node and edge model by generating and assigning aggregated parameters (or embeddings) to each payment node (and funding nodes) and connecting edges, wherein the aggregated parameters include an overall decline rate, a confirmed fraud rate, a total funds received for a payment node, a total funds received from different funding nodes, and other parameters on an account level basis; (vi) further train the graphical node and edge model by associating the features of each transaction to each incoming or outgoing transaction for the payment nodes and/or the funding nodes; and (vii) output from the trained graphical node and edge model an indication of the payment nodes that are determined to be associated with suspicious activity or sometimes referred to as “bad actors” based upon the aggregated parameters, the fraud labels, and the associated features assigned to each payment node. These suspicious payment nodes are associated with accounts that are likely engaged in fraudulent transactions where they are receiving funds or payments in a fraudulent manner.

Once the suspicious payment nodes are identified by the graphical node and edge model, a new graphical multi-layer model is created that focuses on each suspicious payment node and includes an analysis of each incoming transaction to that node over a period of time and at different layers. For example, this suspicious multi-layer model is generated by graphically training the model to show (a) each incoming transaction for the selected payment node, (b) the time that each incoming transaction was received at the selected payment node, and (c) the payment card used with each incoming transaction. This is the first layer of this multi-layer model. This first layer is sometime referred to as the “receiver embedding layer.” The suspicious multi-layer model is further trained to show a second layer sometimes referred to as the “card embedding layer.” The card embedding layer shows each account linked to each payment card used with each incoming transaction. These accounts may also be shown over time indicating which accounts were used to initiate each of the incoming transactions. This suspicious multi-layer model is further trained with the features of each transaction over the period of time. The output from this model is an early-stage suspicious profile that includes card-related transaction parameters generated over time from interactions (transactions) processed over a payment network with a fraudulent payment node. In other words, this final multi-layered model may be used to identify payment nodes in the early stages of being a fraudulent payment node or a fraudulent account that is newly interacting with the payment network. This allows the payment network to prevent these fraudulent payment nodes from engaging with legitimate funding nodes (payees) over the payment node even in those cases where the payment node is new to the network. In some examples, this suspicious multi-layer model is based upon one or more machine-learning (ML) algorithms.

As described herein, transactions that are processed over a payment network may have features that are associated with each transaction. These features may include a variety of different data elements that are associated with each transaction. These features may be used as a profile for each transaction and indicate how, when and where the transaction was performed. For example, the features of a transaction may be communicated over the payment network as part of an ISO8583 or ISO20022 compliant message through an authorization message or over the Internet through an authentication message associated with the transaction. The authentication message may, for example, use a 3DS2 protocol (or subsequent versions of the 3DS protocol) and include a variety of data elements associated with the transaction. These features are stored in memory and used as part of the AI tools when training a model to identify future fraudulent transactions and bad actors.

The following Table 1 lists a number of the data elements or features that are used in the 3DS2 Protocol for authentication. Those of skill in the art will appreciate that the number of rich data elements could grow beyond those listed below (e.g., in future versions of the 3DS Protocol), and could include over one hundred and seventy data elements. Further, an app-based transaction (e.g., carried out using a mobile computing device) could provide even more data elements than browser-based transactions. In addition, a transaction performed using an Android device could have over one hundred thirty additional elements. The authentication data may also be divided by category, such as: transaction data (amount, currency, date, and time), device data (IP address, device info, and channel data), cardholder data (account number and shipping address), and merchant data (name, category, and country).

TABLE 1

| | Data Element |
|---|---|
| 1 | 3DS Requestor Authentication Information |
| 2 | 3DS Requestor Challenge Indicator |
| 3 | 3DS Requestor ID |
| 4 | 3DS Requestor Initiated Indicator |
| 5 | 3DS Requestor Name |
| 6 | 3DS Requestor Non-Payment Authentication Indicator |
| 7 | 3DS Requestor Prior Transaction Authentication Information |
| 8 | 3DS Requestor URL |
| 9 | 3DS Server Operator ID |
| 10 | 3DS Server Reference Number |
| 11 | 3DS Server Transaction ID |
| 12 | 3DS Server URL |
| 13 | Account Type |
| 14 | Acquirer BIN |
| 15 | Acquirer Merchant ID |
| 16 | ACS Challenge Mandated Indicator |
| 17 | ACS Counter ACS to SDK |
| 18 | ACS HTML |
| 19 | ACS Operator ID |
| 20 | ACS Reference Number |
| 21 | ACS Rendering Type |
| 22 | ACS Signed Content |
| 23 | ACS Transaction ID |
| 24 | ACS UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

The authorization message is in an ISO 8583 or ISO 20022 message format for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

The methods and systems described herein may be implemented using computer programming or engineering techniques including computer software, firmware, hardware or any combination or subset thereof, wherein the technical effect may be achieved by performing at least one of the following steps.

As used herein, an acquiring bank or acquirer is typically a bank (or financial institution) at which a merchant holds an account. Further, an issuing bank or issuer (or financial institution) is typically a bank at which a customer or cardholder holds an account. The account may be debited or charged through the use of a debit card, a credit card, or another type of payment card as described herein.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account data, such as mobile phones, smartphones, smart cards, digital wallets, personal digital assistants (PDAs), key fobs, and/or computers. Each type of payment card can be used as a method of payment for performing a transaction. In addition, cardholder account behavior can include but is not limited to purchases, management activities (e.g., balance checking), bill payments, achievement of targets (meeting account balance goals, paying bills on time), and/or product registrations (e.g., mobile application downloads).

As used herein, the term “home payment network” and related terms (e.g., “home network”) refers to a first payment processing network where a cardholder initiates a payment card transaction with a merchant. Entities within the home payment network may include the cardholder, the issuer, the acquirer, the merchant and/or a home payment network. Any of the in-network entities may register for marketplace enrichment operations, as described in detail herein, provided by one or more off-network marketplace providers that are separate and distinct from any of the in-network entities included in the home payment network. For example, a payment transaction, initiated on the home payment network may be transmitted in an ISO® 8583 compliant data message or ISO® 20022 compliant message.

As used herein, the term “network processor” or “payment processor” and related terms (e.g., “home network processor”) refers to computer system(s) associated with a payment network that may be used to communicate data between computer systems associated with an issuer bank, a cardholder, a merchant, an acquirer bank, a payment aggregator, a payment gateway, a government, a financial technology (“Fintech”) system, and/or an account clearing house (“ACH”) system, and communicate with off-network computer system(s) that may be used to provide marketplace operations. Also, as used herein, the home network processor may be configured to receive marketplace operation requests from a requestor and send marketplace operation requests to the translation module or directly to the off-network marketplace or marketplace providers.

As used herein, a funding node is a person or an entity that is sending or transferring the requested funding amount to the payment node when requested by the payment node when the requested transaction is approved or authorized by the funding node. In case the requested transaction is declined, no funding amount may be transferred to the payment node.

As used herein, a processor includes a programmable system including systems using microcontrollers, reduced instruction set circuits (RISC), application specific integrated circuits (ASICs), logic circuits, and any other circuit or processor capable of executing the functions described herein. The above examples are example only, and thus are not intended to limit the definition and/or meaning of the term “processor” in any way.

In one embodiment, computer-executable instructions are provided and are embodied on a non-transitory computer readable storage medium. The computer-executable instructions cause a computer executing the instructions to utilize a Structured Query Language (SQL) with a client user interface front-end for administration and a web interface for standard user inputs and reports. In an example embodiment, the system is web-enabled and is run on a business entity intranet. In an alternative embodiment, the system is fully accessible by individuals having authorized access from outside a firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

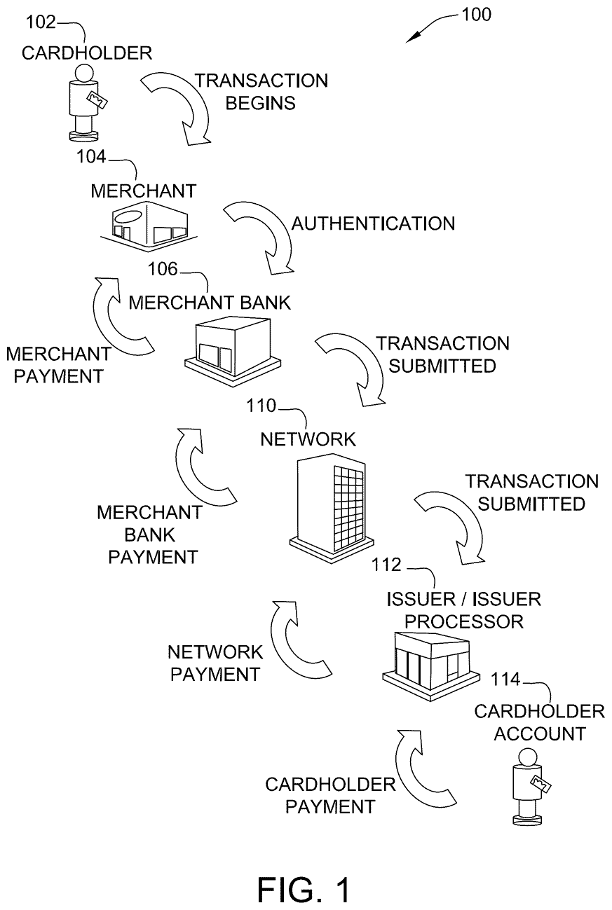

FIG. 1 is a schematic diagram illustrating an example multi-party payment processing network system 100 for enabling payment transactions in which merchants 104 and card issuers 112 do not necessarily have a direct, one-to-one interaction. Embodiments described herein may relate to a payment card system, such as a credit card or debit card payment processing system or a direct payment processing system that uses the Mastercard® interchange network (Mastercard is a registered trademark of Mastercard International Incorporated located in Purchase, New York). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer” issues a payment card, such as a credit or debit card, to a consumer or cardholder 102, who uses the payment card to tender payment for a purchase from a merchant 104. To accept payment with the payment card, merchant 104 must normally establish an account with a financial institution that is part of the financial payment system. This financial institution is usually called the “merchant bank,” the “acquiring bank,” or the “acquirer,” such as a merchant bank 106. When cardholder 102 tenders payment for a purchase with a payment card, merchant 104 sends an authorization request message to merchant bank 106 for the amount of the purchase. The request may be performed over the telephone, but may be also performed through the use of a computer system having access to a website or app enabling input of cardholder's 102 account information, or the use of a point-of-sale device, which reads cardholder's 102 account data from a magnetic stripe, a chip, or embossed characters on the payment card and communicates electronically with the transaction processing computers of merchant bank 106. Alternatively, merchant bank 106 may authorize a third party to perform transaction processing on its behalf. In this case, the point-of-sale device will be configured to communicate with the other party. Such other party is usually called a “merchant processor,” an “acquiring processor,” or a “third party processor.”

The merchant bank 106 forwards the authorization request message to an interchange network 110. The interchange network 110 may use authentication products to prevent frauds (e.g., a fraud in a card-not-present (CNP) transaction) and so on. Various authentication products that are used for CNP transaction fraud includes an address verification service, a card verification value, a digital transaction insight (DTI) score generation, a decision intelligence (DI) score generation, and/or information about the merchant such as whether the merchant is included on a blacklist or not, and so on. The interchange network 110 may forward the authorization request with a DI score and/or a DTI score to issuer 112.

Issuer 112 may determine whether cardholder's 102 account 114 is in good standing and whether the purchase is covered by cardholder's 102 available credit limit. Based on these and other determinations, the request for authorization will be declined or accepted. When the request is accepted, an authorization code is issued to merchant 104. And when the request is declined, a reason code may be included in the response message from the issuer 112 to the interchange network 110. The reason code for the declined financial transaction may identify a particular category and a reason for which the financial transaction is declined. However, the reason code specified in the response message to interchange network 110 does not specify which declined transaction is a fraudulent transaction.

The reason code for a declined financial transaction may identify a particular category and a reason for which the financial transaction is declined. For example, a reason code 51 may suggest that the financial transaction is declined due to financial reasons such as insufficient funds, or the financial transaction is over the credit limit. Reason codes 14, 54, and 78 indicate that the financial transaction is being declined due to card or account reasons such as an invalid card number, an expired card, and an invalid or a non-existent account number, respectively. When a financial transaction is declined due to policy reasons, a reason code 65 may be used to suggest that the financial transaction exceeds withdrawal count limit, a reason code 75 may be used to indicate an allowable number of PIN attempts are exceeded, and a reason code 62 may be used to suggest that the card is restricted. A financial transaction may be declined for security reasons, and reasons codes 04, 43, and 55 identify security reasons for which the financial transaction is declined. The reason code 04 may suggest that the card is a captured card. The reason code 43 may suggest that the card is a stolen card, and the reason code 55 may suggest that an invalid PIN is used. The financial transaction may be declined due technical reasons, and reason codes 80 and 30 may be used to suggest a network error and a format error, respectively. A reason code 15 may suggest an invalid issuer.

However, the reason code specified in the response message to interchange network 110 does not specify which declined transaction is a fraudulent transaction. For example, a reason code 34 when included in the response message by the issuer 112, the interchange network 110 may know that the issuer 112 has declined the authorization request for a suspected fraud in the credit card number (or debit card number), and a reason code 83 when included in the response message by the issuer, the interchange network 110 may know that the issuer 112 has declined the authorization request as the issuer 112 believes the authorization request is for a fraudulent transaction. Authorization requests for which a reason code 34 and/or a reason code 83 is returned, the associated transaction may be labeled as a fraudulent transaction by the interchange network 110. However, when the issuer 112 declines an authorization request with a reason code 05 meaning “Do Not Honor,” the issuer 112 indicates to the interchange network 110 that the issue 112 has declined the authorization request but has not identified the corresponding transaction as a fraudulent transaction. Accordingly, declined transactions with reason codes 34 and/or 83 may be labeled as fraudulent transactions, but declined transactions with reason code 05 may not be labeled as fraudulent transactions.

Since the authorization requests are declined based on the risk models or fraud detection models used by the issuer 112, and as the more fraudulent transactions are identified by the issuer 112, more fraudulent definitions (or patterns) of the fraudulent transactions may be added to database of declined transactions (or fraudulent transactions) of the issuer 112. However, the interchange network 110 and/or the acquirer (or the merchant bank 106) may not be aware of these emerging fraud patterns or the bad actors or fraudsters whose transactions are getting declined by the issuer 112.

FIG. 1 above thus describes an operational flow of transactions between the merchant (or acquirer) and the issuer. The merchant (or acquires) may be referred to as a payment node and the issuer may be referred to as a funding node as described above. In addition to the payment card transaction described above, system 100 may also be used for pushing or pulling money between parties. In other words, instead of initiating a payment made to a merchant at a website or at a POS device, the payment transaction may be initiated using an app that allows a party to send or receive money from another party. In this case, the party that receives the payment (or the party's account) is the payment node and the party (or the party's account) that is sending the money is the funding node.

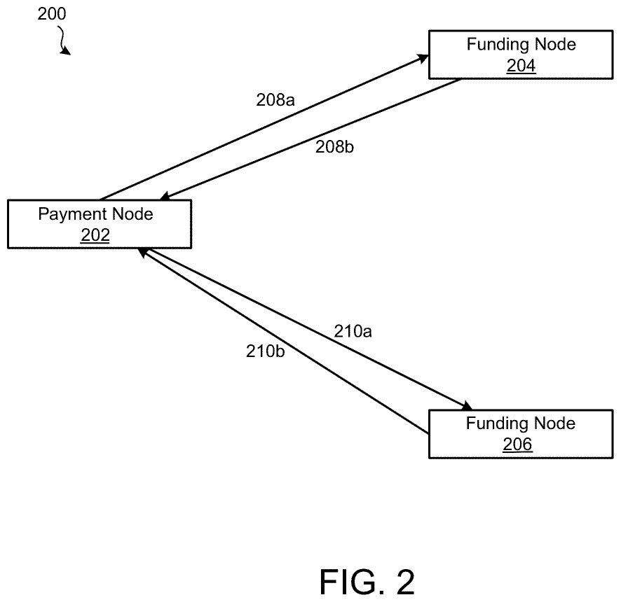

FIG. 2 is a diagram illustrating a payment system 200 that includes a payment node (or a payee or payee device) 202 and two different funding nodes (or payors or payors devices) 204 and 206. The payment system 200 is similar to system 100 shown in FIG. 1. The payment node 202 may be associated with a plurality of different payment cards or account numbers. For example, the payment node 202 may utilize the same payment card and/or different payment cards when receiving payments from funding nodes 204 or 206. In some cases where payment node 202 is a fraudster or bad actor, the payment node 202 may attempt multiple transactions (pull payments) using different payment cards with the same funding node (e.g., the funding node 204 or the funding node 206). Additionally, or alternatively, the payment node 202 may attempt a first set of transactions using a first set of payment cards with the funding node 204 and a second set of transactions using a second set of payment cards with the funding node 206. The cards included in the first set of cards may or may not be included in the second set of cards.

In the example embodiment, the payment node 202 may send a request for authorization 208a to the funding node 204 for a transfer of a funding amount from an account associated with the funding node 204, and the funding node 204 may decline the request for authorization and send a declined response 208b. The payment node 202 may send a request for authorization 210a to the funding node 206 for a transfer of a funding amount from an account associated with the funding node 206, and the funding node 206 may approve the request for authorization and send an approved response 210b. Both requests for authorizations 208a and 210a may be initiated with an intent to commit fraud using different cards. However, the funding node 204 may decline the authorization request 208a for some reasons, and the funding node 206 may approve the authorization request 210a. Accordingly, while the payment node 202 attempts to commit fraud using many different cards, the payment node 202 may succeed in committing fraud with certain payment cards and/or with certain funding nodes, and may fail in committing fraud with certain payment cards and/or with certain funding nodes.

In some examples, the payment node 202 may try committing fraud using a known bank identification number (BIN). In other words, the payment node 202 may use the same BIN number (e.g., a sequence of the first four or six digits of the payment card that identifies the issuing bank) while trying random numbers for the remaining numbers of the payment card. Accordingly, in order to identify bad actors (or fraudsters) at an early stage and to advance DI modeling, graphical modeling may be performed at the payment node as described herein using transactions that are declined transactions and/or labeled as fraudulent transactions. Additionally, or alternatively, the graphical modeling approach described herein may be performed for any combination of a payment node, a BIN number, and/or a wallet identifier. In some examples, by using the graphical modeling approach at the account level (or with regards to a payment node level), fraud detection at the transaction level may be improved. The payment node may be within the payment processing network or outside of the network, and based upon the graphical modeling approach at the payment node level, funds may be traced including identifying the originating account from which the funds were transferred (e.g., funding node), the destination account to which the funds were transferred to (e.g., payment node), and the path between the two accounts (e.g., two nodes). Accordingly, based upon the graphical modeling approach at the node level (e.g., the payment node and/or the funding node), a set of profile features may be determined that may improve a fraud detection model that is configured to identify bad actors or fraudsters at an early stage. In other words, once a bad action payment node is identified, the set of profile features associated with that bad actor analyzed over time may be used to identify other bad actors and may be used to decline transactions associated with the identified bad actors or fraudsters at the interchange network 110.

Currently known conventional fraud detection models are unable to detect bad actors at an account level and at an early stage. The ratio of actual fraud detection (e.g., transaction detection rate (TDR)) to transaction false positive rate (TFPR) is relatively low with these known processes. It is desirable to have a higher value for the TDR and a lower value for the TFPR for a highly efficient fraud detection model. In other words, the parties involved in these payment transaction systems prefer a fraud detection model that identifies a higher number of true fraudulent transactions along with a lower number of legitimate transactions as fraudulent transactions. And the best case scenario is where all of the fraud detected transactions (TDR) are detected and no legitimate transactions (TFPR) are erroneously detected in that set. When the set of transaction features identified based on a graphical modeling approach with regards to the payment node (or the funding node) are used in a ML model, the number of true fraudulent transactions detected are increased substantially and the number of legitimate transactions identified as fraudulent transactions are decreased. In other words, using the set of features identified based on this modeling approach with regard to the payment node (or the funding node) improves the ML models used to later identify fraudulent transactions and/or other bad actor nodes.

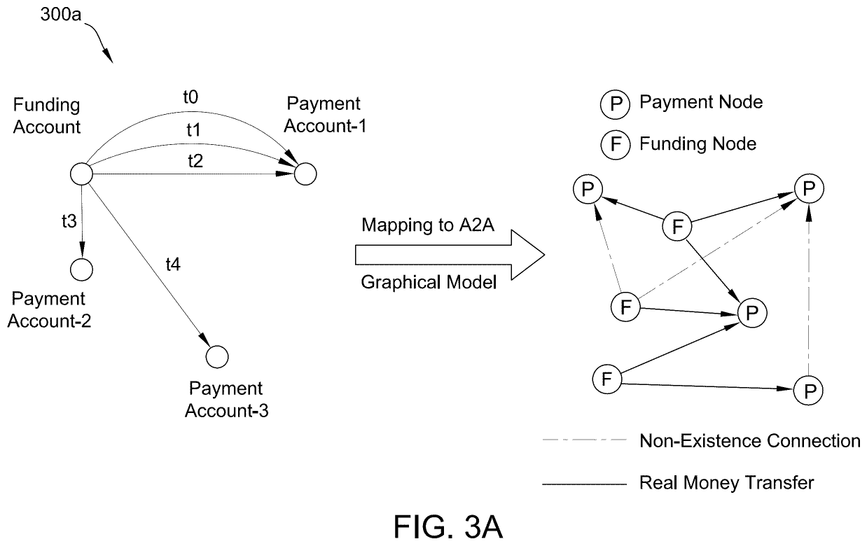

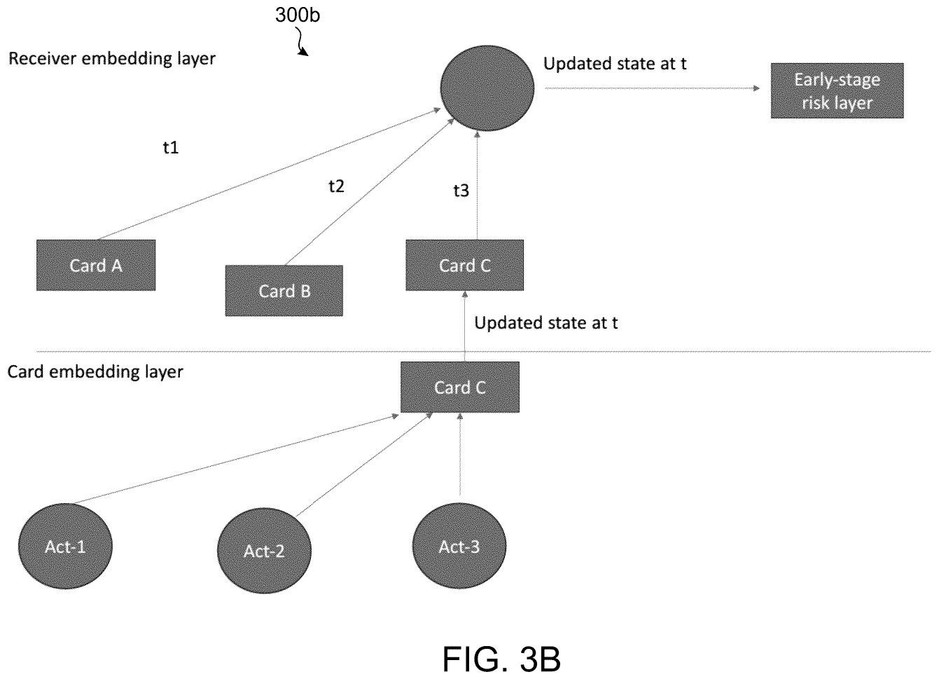

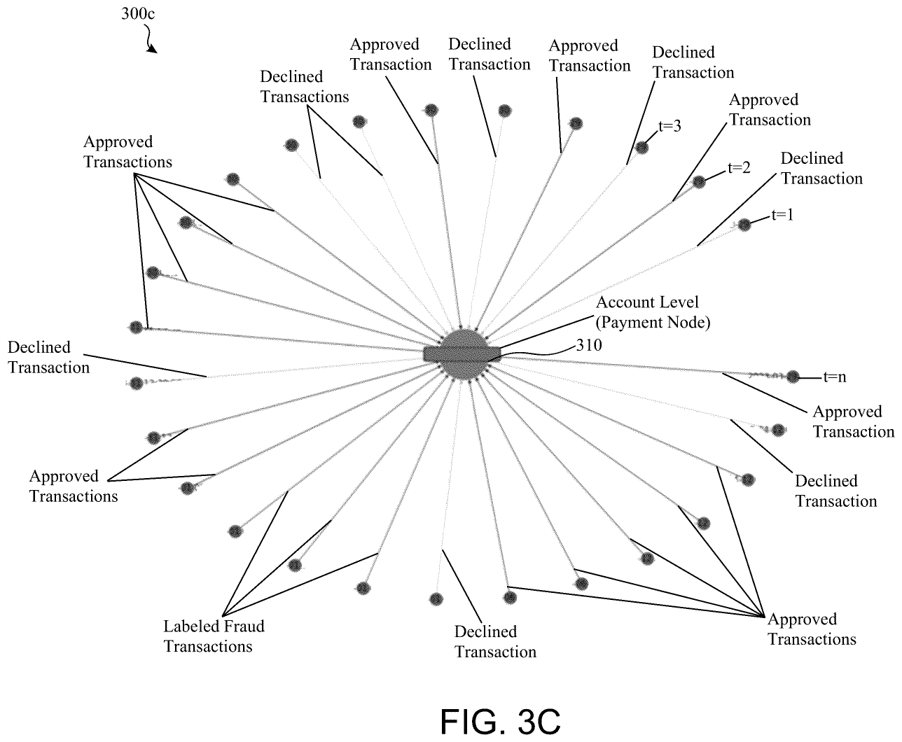

FIG. 3A is an illustration of mapping transactions into an account-to-account (A2A) graphical model with nodes and edges. Specifically, FIG. 3A illustrates a mapping of an A2A graphical model 300a based upon a plurality of transactions between one or more funding nodes and a plurality of payment accounts (or payment nodes). In FIG. 3A, a plurality of transactions t₀, t₁, t₂, t₃, and t₄ are shown as being performed over time between the funding account and several different payment accounts including payment account-1, payment account-2, and payment account-3. In other embodiments, other payment nodes and funding nodes along with other transactions could also be included. In FIG. 3A, transactions t₀, t₁, and t₂ are shown as being between the funding account and payment account-1, while transactions t₃ and t₄ are performed between the funding account and payment account-2 and between the funding account and payment account-3, respectively. While the transactions, the funding account, and the payment accounts shown in FIG. 3A are for example only, these transactions which occurred at different times between the payment accounts (or payment nodes) and the funding node may be mapped to an A2A graphical model (also referenced herein as a graphical node and edge model), as shown in FIG. 3A. The graphical model shows the connections and/or transactions between various account nodes (e.g., payment nodes and/or funding nodes). As described herein, the payment node is a receiver of funds (e.g., a payee), and the funding node is a sender of funds (e.g., a payor) in a transaction. Accordingly, from the plurality of transactions that are performed at different times over a specific period, the A2A graphical model may be generated showing one or more payment nodes and one or more funding nodes associated with the plurality of transactions performed over time. In some embodiments, by way of a non-limiting example, the plurality of transactions used for generating the A2A graphical model may include transactions performed over the past 120 days or any other period of time.

In other words, exemplary embodiments of the graphical model described herein may (i) identify all transactions initiated within an account-to-account (A2A) ecosystem including features associated with each transaction; (ii) build a transaction graphical model showing all transactions initiated from one or more funding sources (or payors or funding nodes) to one or more payment receiving sources (or payees or payment nodes) over a period of time; (iii) train and build an A2A graphical model (or a graphical node and edge model) that shows all completed (existent) transactions including legitimate and fraudulent transactions between the funding nodes and the payment nodes, and that shows all declined (non-existent) transactions between the funding nodes and the payment nodes; (iv) further train the A2A graphical model by applying fraud labels to each transaction that has been labeled a fraudulent transaction such that each payment node indicates one or more incoming transactions (edges) with each incoming transaction being labeled as either approved, declined, or confirmed fraudulent, and doing the same for each outgoing transaction from the funding nodes (see FIG. 3C showing labeled transactions); (v) further train the A2A graphical model by generating and assigning aggregated parameters (or embeddings) to each payment node (and funding node) and connecting transactions (edges), wherein the aggregated parameters include an overall decline rate, a confirmed fraud rate, a total funds received for a payment node, a total funds received from different funding nodes, and other parameters on an account level basis; (vi) further train the A2A graphical model by associating the features to each incoming or outgoing transaction for the payment nodes and/or the funding nodes; and (vii) output from the trained A2A graphical model an indication of the payment nodes that are determined to be associated with suspicious activity or bad actors based upon the aggregated parameters, the fraud labels, and the associated features assigned to each payment node. These suspicious payment nodes are associated with accounts and/or devices that are likely engaged in fraudulent transactions where they are receiving funds or payments in a fraudulent manner. Accordingly, future transactions originating from these suspicious payment nodes may be prevented at the interchange network 110.

The A2A graphical model, which may be an ML or AI based model, may be trained using data including, but not limited to, an amount of funds transferred between each pair of a payment node and a funding node, and/or a number of transactions, including transactions identified as fraudulent transactions, between each pair of a payment node and a funding node. In some examples, the A2A graphical model may be trained using one or more hyper technical connections. A hyper technical connection is a connection between two accounts between which a funds transfer did not occur, or a declined transaction between a payment node and a funding node. Additionally, or alternatively, the A2A graphical model may be trained using data including connections between accounts between which a transfer occurred, or approved transactions including legitimate or fraudulent transactions. Accordingly, the A2A graphical model may be trained using data including existent connections and/or non-existent connections, and transactions that occurred between various payment nodes and funding nodes. The trained A2A graphical model may then be retrained or tuned using embeddings of the payments and/or fundings, and fraud labels as applied to various transactions between the connections and/or the payment and funding nodes. As described herein, the transactions may be labeled as fraudulent transactions based on reporting by actual owners of the cards used in committing frauds by the bad actors or fraudsters.

In some examples, the trained A2A graphical model may also be trained to score all transactions of one or more payment nodes. The transactions of one or more payment nodes may be scored based on likelihood of a transaction being a fraudulent transaction. The likelihood of a transaction being a fraudulent transaction may be determined based on various factors including, but not limited to, (i) an amount of transaction; (ii) a transaction time; (iii) a city, state, and/or a country where the transaction originated; (iv) a merchant associated with the transaction; (v) a rate of declined transactions; (vi) a rate of transactions identified as fraudulent transactions; and/or (vii) a rate of transactions being processed at a selected time or for a selected account, etc.

The A2A graphical model trained as described above may improve performance of fraud detection that has a higher number TDR and a lower number TFPR. While it is described here that the A2A graphical model is trained using transactions associated with a payment node to identify fraudulent transactions or suspected payment nodes involved in fraudulent transactions, the A2A graphical model may be trained using transactions associated with a funding node to identify fraudulent transactions or suspected funding nodes involved in fraudulent transactions. In other embodiments, the A2A graphical model may be trained to identify modey laundering transactions or suspected money laundering transactions so that steps may be taken and/or additional computer resources may be deployed to prevent further money laudering.

In some examples, using the trained A2A graphical model as described above, suspected or risky payment accounts (or payment nodes) and/or funding accounts (or funding nodes) may be identified for further evaluation by an agent. The agent may examine details of transactions between the identified suspected or risky payment accounts (or payment nodes) and/or funding accounts (or funding nodes), and based upon the examination, the agent may put the transactions into separate buckets or clusters wherein each bucket is assigned a different label or category for the transaction. Additionally, or alternatively, the trained A2A graphical model may suggest, based upon examination of details of transactions between the identified suspected or risky payment accounts (or payment nodes) and/or funding accounts (or funding nodes), a specific bucket to which the particular transaction may be assigned. By way of a non-limiting example, a first bucket may correspond with transactions approved by the funding accounts and later reported as fraudulent transactions, a second bucket may correspond with transactions approved by the funding accounts and never reported as fraudulent transactions, and a third bucket may correspond with transactions that were not approved by the funding accounts.

One or more patterns may be identified from the transactions associated with each of the three buckets. From the identified one or more patterns, a particular payment account and/or a particular funding account may be recognized as an account associated with a bad actor or a fraudster and used for committing a fraud. Additionally, or alternatively, all transactions associated with the particular payment account and/or the particular funding account may be labeled or identified as fraudulent transactions. The A2A graphical model may then be retrained using the transactions associated with the particular payment account and/or the funding account labeled or annotated as fraudulent transactions. The retrained A2A graphical model may further improve detection of fraudulent transactions and/or the bad actors or fraudsters. In some examples, the retrained A2A graphical models may be used to identify and prevent future transactions of the identified bad actor or the fraudster at the interchange network 110 while the transactions are in progress (e.g., in real-time or near real-time) to prohibit fraud on a funding account. In other words, the network 110 would be configured to identify a transaction being processed as being associated with the identified bad actor, and would be further configured to block the transaction (or notify the issuer to approve the blocking) before the transaction is completed.

FIG. 3B is an illustration of a graphical multi-layer model 300b based on the A2A graphical model shown in FIG. 3A. In some examples, based on the identified suspected or risky payment accounts and/or funding accounts, transaction analysis may be performed at two different levels to generate a graphical multi-layer model 300b shown in FIG. 3B. The graphical multi-layer model 300b may include transaction analysis at a card level, and transaction analysis at a receiver level. The card level analysis may include analysis of transactions with reference to a payment card associated with one or more accounts where one or more transactions transferring funds is made. The transaction analysis at the card level may be performed using a neural network (NN) architecture, in which the transaction analysis is performed by an embedding layer (referenced herein as a card embedding layer).

The transaction analysis at the receiver level may identify a receiver (a payment node) receiving funds from one or more payment cards. The transaction analysis at the receiver level may thus include identifying different cards used to receive funds at different times (e.g., using transactions performed at different times as shown in FIG. 3A). Similar to the transaction analysis at the card level, the transaction analysis at the receiver level may be performed using an embedding layer (referenced herein as a receiver embedding layer) of the NN.

In some examples, another embedding layer (e.g., a risk detection embedding layer) of the NN may identify potentially risky elements (e.g., a payment account or payment node, a funding account or funding node, a payment card, and/or a transaction, and so on). The potentially risky element once identified by the risk detection embedding layer may be fed to the card embedding layer and/or the receiver embedding layer. Accordingly, if a transaction associated with a payment card with reference to an account at the card embedding layer is found or determined to be suspected, then at the receiver embedding layer transactions performed using the card with a payment node may also be identified as a suspected payment node. In some examples, other cards used for transactions performed with the suspected payment node may also be identified as potentially suspect cards, and therefore, a greater number of transactions, which are being performed by the likely bad actors or fraudsters may be prevented.

Accordingly, as shown in FIG. 3B, once the suspicious payment nodes are identified by the A2A graphical node and edge model shown in FIG. 3A, a new graphical multi-layer model 300b is created that focuses on each suspicious payment node and includes an analysis of each incoming transaction to that node over a period of time and at the different layers. For example, the suspicious multi-layer model 300b is generated by graphically training the model to show (a) each incoming transaction for the selected payment node, (b) the time that each incoming transaction (t1, t2, and t3) was received at the selected payment node, and (c) the payment card (Card A, Card B, and Card C) used with each incoming transaction. This is the first layer of this multi-layer model 300b. This first layer is sometimes referred to as the “receiver embedding layer.” The suspicious multi-layer model is further trained to show a second layer sometimes referred to as the “card embedding layer.” The card embedding layer shows each account (Act-1, Act-2, Act-3) linked to each payment card used with each incoming transaction. These accounts may also be shown over time indicating which accounts were used to initiate each of the incoming transactions. This suspicious multi-layer model 300b is further trained with the features (described above) of each transaction over the period of time. The output from this model is an early-stage suspicious profile that includes card-related transaction parameters generated over time from interactions (transactions) processed over a payment network with a fraudulent payment node. In other words, this final multi-layered model 300b may be used to identify payment nodes in the early stages of being a fraudulent payment node or a fraudulent account that is newly interacting with the payment network. This allows the payment network to prevent these fraudulent payment nodes from engaging with legitimate funding nodes (payors) over the payment node even in those cases where the payment node is new to the network. In some examples, this suspicious multi-layer model is based upon one or more machine-learning (ML) algorithms.

FIG. 3C is a graphical illustration 300c of a life cycle of a payment node and transactions performed by the payment node. As shown in FIG. 3C, a payment node 310 may have attempted a plurality of transactions with several different funding nodes over a particular time duration (t=0 to t=n). A subset of the plurality of transactions may be approved by corresponding funding nodes. Another subset of the plurality of transactions may be declined by corresponding funding nodes, while another subset of the plurality of transactions may be declined as well as labeled or identified as fraudulent transactions by corresponding funding nodes. In the exemplary embodiment, the payment node that is associated with suspicious or fraudulent activities may disappear after attempting transactions with different funding nodes.

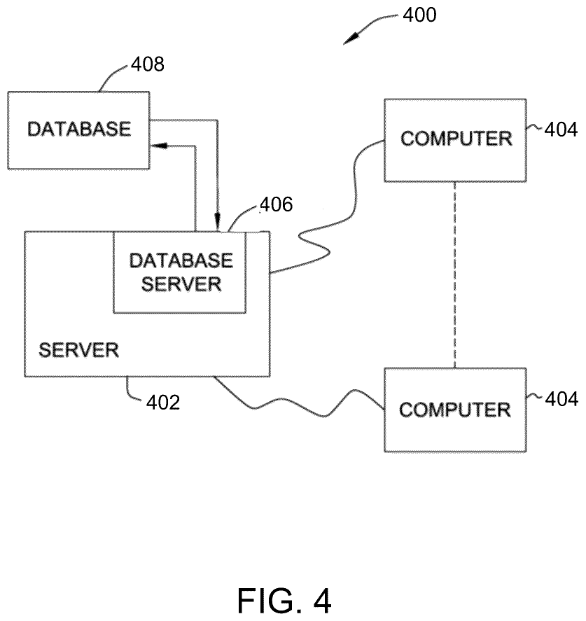

Exemplary methods and systems, as described in the present disclosure, are configured to identify early stage fraud at the account level. These models may be implemented using a computing system and various components as shown in FIGS. 4-6.

FIG. 4 is a simplified block diagram of an example computer system 400 representative of the interchange network 110 in multi-party payment processing network system 100 (shown in FIG. 1). In the example embodiment, system 400 includes a server system 402 and a plurality of client subsystems, also referred to as client systems 404, connected to server system 402. In one embodiment, client systems 404 are computers including a web browser, such that server system 402 is accessible to client systems 404 using the Internet. Client systems 404 are interconnected to the Internet through many interfaces including a network, such as a local area network (LAN) and/or a wide area network (WAN), dial-in connections, cable modems, wireless-connections, and special high-speed ISDN lines. Client systems 404 may be any device capable of interconnecting to the Internet including a web-based phone, personal digital assistant (PDA), or other web-connectable equipment. A database server 406 is connected to a database 408 containing information on a variety of matters, as described below in greater detail. In one embodiment, database 408 is stored on server system 402 and may be accessed by potential users at one of client systems 404 by logging onto server system 402 through one of client systems 404. In any alternative embodiment, database 408 is stored remotely from server system 402 and may be non-centralized.

As discussed below, payment card information including account numbers, payment card numbers, expiration dates, and account statuses, such as whether the account is open or closed, is stored within database 408. Further, data relating to the cardholder of a payment card may also be stored within database 408. Such cardholder data may include, for example, cardholder name and cardholder billing address. Transaction details including authorization requests and statuses for the authorization requests including authorization codes and/or reasons codes for declining the authorization requests may also be stored within database 408.

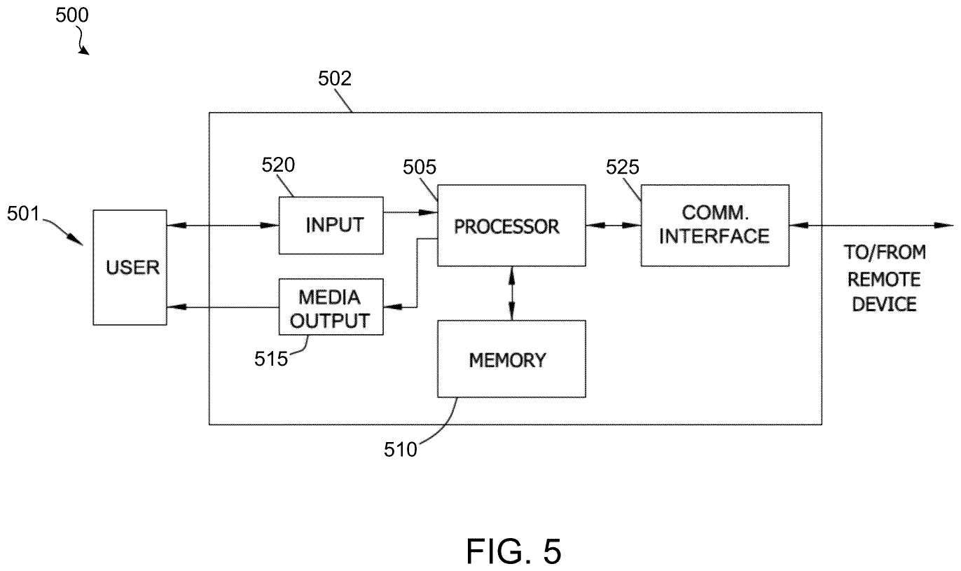

FIG. 5 illustrates an example configuration 500 of a user computer system 502 operated by a user 501 (such as, for example, a cardholder). User/cardholder computer system 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer readable media.

User/cardholder computer system 502 also includes at least one media output component 515 for presenting information to cardholder 501. Media output component 515 is any component capable of conveying information to cardholder 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer system 502 includes an input device 520 for receiving input from cardholder 501. Input device 520 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 515 and input device 520.

Cardholder computer system 502 may also include a communication interface 525, which is communicatively couplable to a remote device such as server system 402 or a web server operated by a merchant. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to cardholder 501 via media output component 515 and, optionally, receiving and processing input from input device 520. A user interface may include, among other possibilities, a web browser and client application. Web browsers enable cardholders, such as cardholder 501, to display and interact with media and other information typically embedded on a web page or a website from server system 402 or a web server associated with a merchant. A client application allows cardholder 501 to interact with a server application from server system 402 or a web server associated with a merchant.

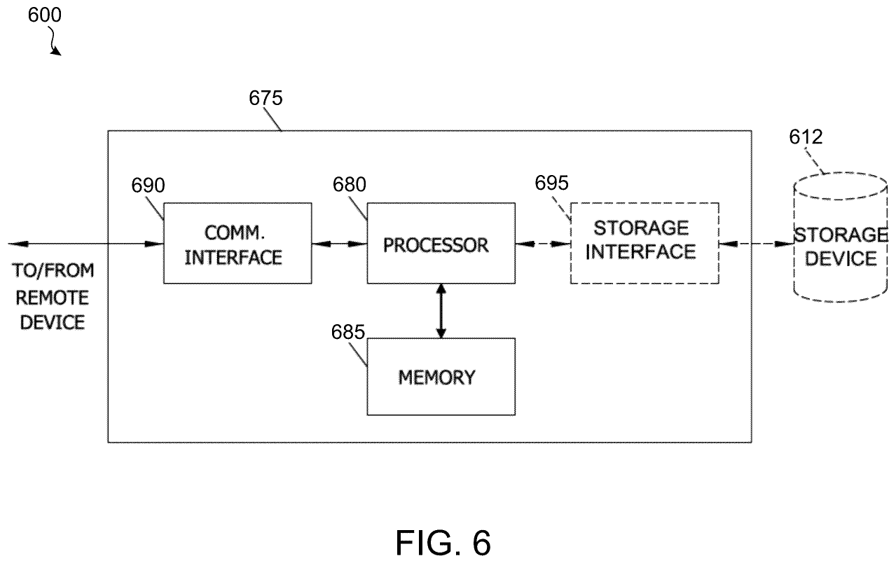

FIG. 6 illustrates an example configuration 600 of a server computer system 675 such as server system 402 (shown in FIG. 4) or interchange network 110 (shown in FIG. 1). Server computer system 675 may include, but is not limited to, database server 406.

Server computer system 675 includes a processor 680 for executing instructions. Instructions may be stored in a memory area 685, for example. Processor 680 may include one or more processing units (e.g., in a multi-core configuration).

Processor 680 is operatively coupled to a communication interface 690 such that server computer system 675 is capable of communicating with a remote device such as cardholder computer system 502 (shown in FIG. 5) or another server computer system 675. For example, communication interface 690 may receive requests from client systems 404 via the Internet, as illustrated in FIG. 4.

Processor 680 may also be operatively coupled to a storage device 612. Storage device 612 is any computer-operated hardware suitable for storing and/or retrieving data. In some embodiments, storage device 612 is integrated in server computer system 675. For example, server computer system 675 may include one or more hard disk drives as storage device 612. In other embodiments, storage device 612 is external to server computer system 675 and may be accessed by a plurality of server computer systems 675. For example, storage device 612 may include multiple storage units such as hard disks or solid-state disks in a redundant array of inexpensive disks (RAID) configuration. Storage device 612 may include a storage area network (SAN) and/or a network attached storage (NAS) system.

In some embodiments, processor 680 is operatively coupled to storage device 612 via a storage interface 695. Storage interface 695 is any component capable of providing processor 680 with access to storage device 612. Storage interface 695 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 480 with access to storage device 612.

Memory area 685 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only and are thus not limiting as to the types of memory usable for storage of a computer program.

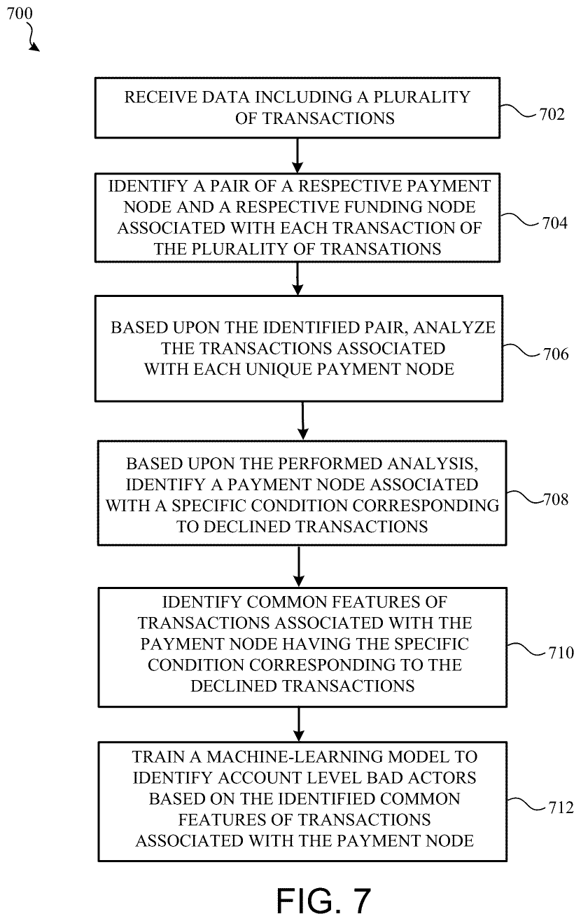

FIG. 7 is a flow diagram of an example method 700 of identifying fraudulent transactions using the A2A graphical model 300a and the graphical multi-layer model 300b described above. The models are configured to identify payment nodes and/or funding nodes that are associated with bad actors or fraudsters. And thereby preventing future fraudulent transactions or activities by the bad actors or fraudsters when the fraudulent transactions are in progress.

In some embodiments, the method 700 may include receiving 702 data including a plurality of transactions. The data may be received from the payment network 110 or from the issuer 112 and/or the acquirer 104. The plurality of transactions may include a set of declined transactions and another set of approved transactions. As described herein, the set of declined transaction may include transactions that are declined because these transactions have been identified as fraudulent transactions by the issuer 112. Additionally, or alternatively, the transaction in the set of declined transactions may be fraudulent transactions but may have been declined for other reasons. Similarly, the set of approved transactions may include transactions which are fraudulent transactions but approved by the issuer 112.

In some embodiment, the method 700 may include identifying 704 a pair of a respective payment node and a respective funding node associated with each transaction of the plurality of transactions. As shown in FIG. 2, each transaction has an associated payment node (a person or an entity receiving funds) and an associated funding node (a person or an entity sending the funds to the payment node). Accordingly, a plurality of pairs of a respective payment node and a respective funding node may be identified from the plurality of transactions. Oftentimes, data includes transactions which use different accounts or cards to perform transactions with the same funding node or different funding nodes. As described herein, the transactions may be performed by the payment node using different cards at the same BIN number level. Accordingly, from the plurality of transactions, a payment node and a funding node with one or more transactions using one or more different cards may be identified.

In some embodiments, the method 700 may include, based upon the identified pair of the respective payment node and the respective funding node associated with each transaction of the plurality of transactions, performing 706 analysis of transactions associated with each unique payment node. The analysis of the transactions performed with respect to each unique payment node may identify different cards or accounts used with the payment node to perform transactions with one or more funding nodes. The transactions performed by the payment node may include approved or declined transactions. The transactions by the payment node may be declined as being found to be fraudulent transaction by one or more issuers 112.

In some embodiments, the method 700 may include, based upon performed analysis, determining or identifying 708 whether the payment nodes is associated with a specific condition corresponding to the declined transactions. By way of a non-limiting example, the specific condition may be number of declined transactions originated by the payment node exceeding a predetermined number of percentage threshold, for example, 3% or 5%. The specific condition may be a city, a state, and/or a country from where the transactions originated. In some examples, a frequency of transactions originated in a specific period may also be relevant for the specific condition.

In some embodiments, the method 700 may include identifying 710 common features of transactions associated with the payment node and which transactions are declined transactions. The common features may be one or more unique patterns, e.g., transactions above certain amount, transactions originated at certain time, transactions originated from a specific location, and so on.

In some embodiments, the method 700 may include training 712 an ML model to identify bad actors based on the identified common features of the transactions associated with the payment node. By way of a non-limiting example, the ML model may be implemented using a neural network having a plurality of embedding layers, described herein.

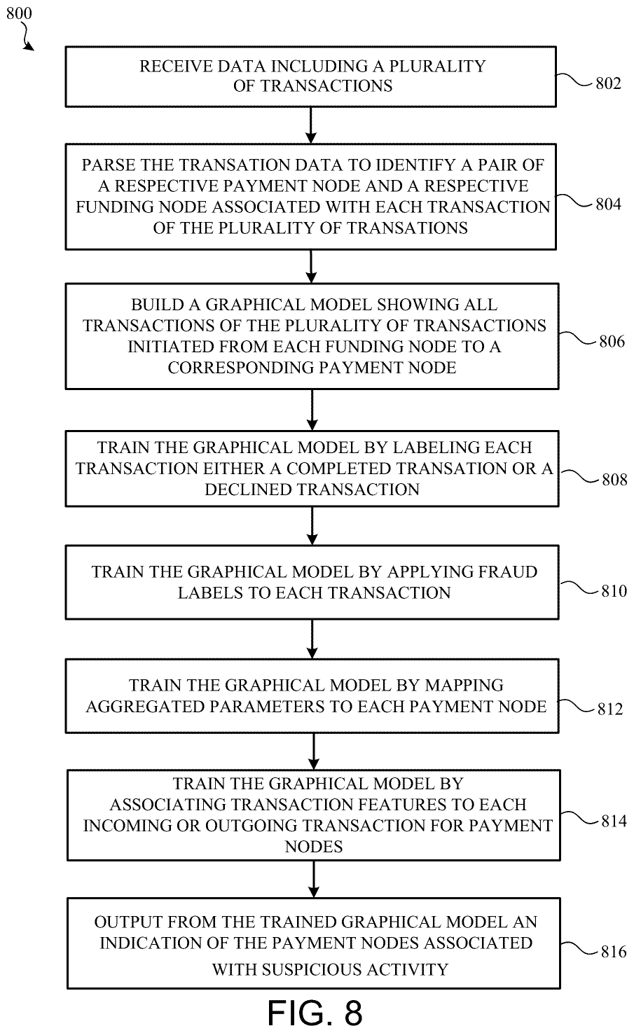

FIG. 8 is a flow diagram 800 of another example method of identifying payment nodes associated with suspicious activity, which may be implemented by the computers system shown in FIG. 4. The method operations may include receiving 802 transaction data for a plurality of transactions processed over a payment network. The plurality of transactions may include a first set of declined transactions and a second set of approved transactions. The transaction data for the plurality of transactions may be parsed 804 to identify each pair of a respective payment node and a respective funding node associated with each transaction of the plurality of transactions. The method operations may further include building 806 a graphical model showing all transactions of the plurality of transactions initiated from each funding node to a corresponding payment node over a period of time. The period of time may be predetermined or preconfigured. The graphical model may be trained 808 by labeling each transaction as either a completed transaction or a declined transaction. Further, the graphical model may be further trained 810 by applying fraud labels to each transaction. Additionally, the graphical model may be further trained 812 by mapping aggregated parameters to each payment node. The method operations may also include training 814 the graphical model by associating transaction features to each incoming or outgoing transaction for the payment nodes, and outputting 816 from the trained graphical model an indication of the payment nodes that are determined to be associated with suspicious activity based upon the aggregated parameters, the fraud labels, and the associated features assigned to each payment node.

In some embodiments, the graphical model may be a multi-layer graphical model including a receiver embedding layer. The multi-layer graphical model may be built and trained to further include a card embedding layer. The card embedding layer may illustrate a plurality of accounts linked to a payment card used for a plurality of incoming transactions. In the exemplary embodiment, the multi-layer graphical model may illustrate each incoming transaction of the plurality of incoming transactions and respective payment account as a time-based graph as shown in FIG. 3A, for example. The multi-layer graphical model may be built and trained using a neural network.

The computer-implemented methods discussed herein may include additional, less, or alternate actions, including those discussed elsewhere herein. The methods may be implemented via one or more local or remote processors, transceivers, servers, and/or sensors (such as processors, transceivers, and/or servers, and/or via computer-executable instructions stored on non-transitory computer-readable media or medium.

The embodiments described herein thus provides A2A graphical models that may be easily trained and may illustrate data in a clean condensed way, thereby improving the graphical modeling system by requiring fewer computing resources. Further, the graphical models built and trained as described herein may also improve fraud detection with less legitimate transactions being identified as fraudulent transactions.

In some embodiments, the server 402 and/or the server 675 are configured to implement machine learning, such that the server 402 and/or the server 675 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to string of data. ML outputs may include, but are not limited to identified objects, items classifications, and/or other data extracted from the data strings. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of data with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may be configured to utilize artificial intelligence and/or machine learning techniques. For instance, the system may employ supervised or unsupervised machine learning techniques, which may be followed by, and/or used in conjunction with, reinforced or reinforcement learning techniques. The system may employ the techniques utilized for ChatGPT.

Based upon these analyses, the processing element may learn how to identify characteristics and patterns that may then be applied to analyzing and classifying objects. The processing element may also learn how to identify attributes of different objects. This information may be used to determine which classification models to use and which classifications to provide.

The computer-implemented methods discussed herein may include additional, less, or alternate actions, including those discussed elsewhere herein. The methods may be implemented via one or more local or remote processors, and/or transceivers, and/or via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

In some embodiments, the system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include, but are not limited to, analog and digital signals, image data, video data, and the like. ML outputs may include, but are not limited to, digital signals, and the like. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A graphical modeling computer system comprising at least one memory, and at least one processor in communication with the at least one memory, the at least one processor configured to:
receive transaction data for a plurality of transactions processed over a payment network, the plurality of transactions including a set of declined transactions and a set of approved transactions;
parse the transaction data to identify each pair of a respective payment node and a respective funding node associated with each transaction of the plurality of transactions;
build a graphical model showing all transactions of the plurality of transactions initiated from each funding node to a corresponding payment node over a period of time;
train the graphical model by labeling each transaction as either a completed transaction or a declined transaction;
train the graphical model by applying fraud labels to each transaction;
train the graphical model by mapping aggregated parameters to each payment node;
train the graphical model by associating transaction features to each incoming or outgoing transaction for the payment nodes;
output from the trained graphical model an indication of the payment nodes that are determined to be associated with suspicious activity based on the aggregated parameters, the fraud labels, and the associated features assigned to each payment node;
based on the indication, identify, at an account level associated with the payment nodes determined to be associated with suspicious activity, one or more future transactions as originating from the payment nodes determined to be associated with suspicious activity; and
prevent the one or more future transactions originating from the payment nodes determined to be associated with suspicious activity from being completed by blocking the one or more future transactions while the one or more future transactions are in progress.

2. The graphical modeling computer system of claim 1, wherein the at least one processor is further configured to:
in response to outputting an indication that a first payment node has engaged in suspicious activity, build a graphical multi-layer model that includes an analysis of incoming transactions to the first payment node over a period of time, wherein the graphical multi-layer model is generated by graphically training the graphical multi-layer model to show (i) incoming transactions for the first payment node, (ii) a time that the incoming transactions were received at the first payment node, and (iii) a payment card used with the incoming transactions;
train the graphical multi-layer model with features data of each incoming transaction over the period of time; and
output from the graphical multi-layer model an early-stage suspicious profile including card-related transaction features data over time indicating suspicious transaction patterns.

3. The graphical modeling computer system of claim 1, wherein the graphical model further includes a multi-layer graphical model and includes at least a receiver embedding layer and a card embedding layer, and wherein the at least one processor is further configured to generate and train the multi-layer graphical model to include the card embedding layer that illustrates a plurality of accounts linked to a payment card used for a plurality of incoming transactions.

4. The graphical modeling computer system of claim 3, wherein the multi-layer graphical model illustrates each incoming transaction of the plurality of incoming transactions and respective payment account as a time-based graph.

5. The graphical modeling computer system of claim 3, wherein the multi-layer graphical model is generated and trained using a neural network.

6. The graphical modeling computer system of claim 3, wherein the multi-layer graphical model further includes at least one embedding layer configured to identify elements within the graphical model that are likely engaged in anomalous behavior.

7. The graphical modeling computer system of claim 6, wherein the identified elements comprise at least one of: (i) a payment card; (ii) a transaction performed; (iii) a payment node or a payment account; and (iv) a funding node or a funding account.

8. The graphical modeling computer system of claim 1, wherein the at one processor is further configured to score each transaction of the plurality of transactions associated with the corresponding payment node for a likelihood of being a fraudulent transaction.

9. The graphical modeling computer system of claim 8, wherein the likelihood of each transaction being the fraudulent transaction is determined based on one or more of: (i) an amount of the transaction; (ii) a transaction time; (iii) a city, state, and/or a country where the transaction originated; (iv) a merchant associated with the transaction; (v) a rate of declined transactions; and (vi) a rate of transactions identified as fraudulent transactions.

10. A computer-implemented method performed using a graphical modeling computer device including a memory and at least one processor in communication with the memory, the method comprising:
receiving transaction data for a plurality of transactions processed over a payment network, the plurality of transactions including a first set of declined transactions and a second set of approved transactions;
parsing the transaction data to identify each pair of a respective payment node and a respective funding node associated with each transaction of the plurality of transactions;
building a graphical model showing all transactions of the plurality of transactions initiated from each funding node to a corresponding payment node over a period of time;
training the graphical model by labeling each transaction as either a completed transaction or a declined transaction;
training the graphical model by applying fraud labels to each transaction;
training the graphical model by mapping aggregated parameters to each payment node;
training the graphical model by associating transaction features to each incoming or outgoing transaction for the payment nodes;
outputting from the trained graphical model an indication of the payment nodes that are determined to be associated with suspicious activity based on the aggregated parameters, the fraud labels, and the associated features assigned to each payment node;
based on the indication, identifying, at an account level associated with the payment nodes determined to be associated with suspicious activity, one or more future transactions as originating from the payment nodes determined to be associated with suspicious activity; and
preventing the one or more future transactions originating from the payment nodes determined to be associated with suspicious activity from being completed by blocking the one or more future transactions while the one or more future transactions are in progress.

11. The computer-implemented method of claim 10 further comprising:
in response to outputting an indication that a first payment node has engaged in suspicious activity, building a graphical multi-layer model that includes an analysis of incoming transactions to the first payment node over a period of time, wherein the graphical multi-layer model is generated by graphically training the graphical multi-layer model to show (i) incoming transactions for the first payment node, (ii) a time that the incoming transactions were received at the first payment node, and (iii) a payment card used with the incoming transactions;
training the graphical multi-layer model with features data of each incoming transaction over the period of time; and
outputting from the graphical multi-layer model an early-stage suspicious profile including card-related transaction features data over time indicating suspicious transaction patterns.

12. The computer-implemented method of claim 10, wherein the graphical model further includes a multi-layer graphical model and includes a receiver embedding layer and a card embedding layer, and the computer-implemented method further comprising generating and training the multi-layer graphical model including the card embedding layer that illustrates a plurality of accounts linked to a payment card used for a plurality of incoming transactions.

13. The computer-implemented method of claim 12, wherein the multi-layer graphical model illustrates each incoming transaction of the plurality of incoming transactions and respective payment account as a time-based graph.

14. The computer-implemented method of claim 12, further comprising building and training the multi-layer graphical model using a neural network.

15. The computer-implemented method of claim 12, wherein the multi-layer graphical model further includes at least one embedding layer configured to identify a risky element.

16. The computer-implemented method of claim 15, wherein the risky element comprises at least one of: (i) a card; (ii) a transaction; (iii) a payment node or a payment account; and (iv) a funding node or a funding account.

17. The computer-implemented method of claim 10, further comprising scoring each transaction of the plurality of transactions associated with the corresponding payment node for a likelihood of being a fraudulent transaction.

18. The computer-implemented method of claim 17, further comprising determining the likelihood of each transaction being the fraudulent transaction based on one or more of: (i) an amount of the transaction; (ii) a transaction time; (iii) a city, state, and/or a country where the transaction originated; (iv) a merchant associated with the transaction; (v) a rate of declined transactions; and (vi) a rate of transactions identified as fraudulent transactions.

19. A non-transitory computer-readable storage medium that includes computer-executable instructions embodied thereon that when the computer-executable instructions are executed by at least one processor of an interchange network computer, the computer-executable instructions cause the at least one processor to:
receive transaction data for a plurality of transactions processed over a payment network, the plurality of transactions including a set of declined transactions and a set of approved transactions;
parse the transaction data to identify each pair of a respective payment node and a respective funding node associated with each transaction of the plurality of transactions;
build a graphical model showing all transactions of the plurality of transactions initiated from each funding node to a corresponding payment node over a period of time;
train the graphical model by labeling each transaction as either a completed transaction or a declined transaction;
train the graphical model by applying fraud labels to each transaction;
train the graphical model by mapping aggregated parameters to each payment node;
train the graphical model by associating transaction features to each incoming or outgoing transaction for the payment nodes;
output from the trained graphical model an indication of the payment nodes that are determined to be associated with suspicious activity based on the aggregated parameters, the fraud labels, and the associated features assigned to each payment node;
based on the indication, identify, at an account level associated with the payment nodes determined to be associated with suspicious activity, one or more future transactions as originating from the payment nodes determined to be associated with suspicious activity; and
prevent the one or more future transactions originating from the payment nodes determined to be associated with suspicious activity from being completed by blocking the one or more future transactions while the one or more future transactions are in progress.

20. The non-transitory computer-readable storage medium according to claim 19, wherein the graphical model further includes a multi-layer graphical model and includes at least a receiver embedding layer and card embedding layer, and wherein the instructions cause the at least one processor to generate and train the multi-layer graphical model to include the card embedding layer that illustrates a plurality of accounts linked to a payment card used for a plurality of incoming transactions.
